(19) United States
(12) Patent Application Publication
(10) Pub. No.: US 2013/0262724 A1
(43) Pub. Date: Oct. 3, 2013

(54) Method and Circuit Arrangement for Transmitting Data Between Processor Modules

(71) Applicants: Bastian Wegener, Partenstein (DE); Lukusa Didier Kabulepa, Erzhausen (DE); Ralf Hartmann, Kriftel (DE); Christian Bitsch, Heppenheim (DE)

(72) Inventors: Bastian Wegener, Partenstein (DE); Lukusa Didier Kabulepa, Erzhausen (DE); Ralf Hartmann, Kriftel (DE); Christian Bitsch, Heppenheim (DE)

(73) Assignee: Continental Teve AG & Co. oHG, Frankfurt (DE)

(21) Appl. No.: 13/885,315

(22) PCT Filed: Aug. 5, 2011
(86) PCT No.: PCT/EP2011/063574

§ 371 Date: Jun. 12, 2013

(30) Foreign Application Priority Data
Nov. 15, 2010 (DE) 10 2010 043 929.0
Apr. 14, 2011 (DE) 10 2011 007 437.6

(51) Int. Cl. G06F 13/364

(52) U.S. Cl. CPC G06F 13/364
USPC 710/110

(57) ABSTRACT

The invention relates to a circuit arrangement for forming a digital interface comprising a digital data bus, which exchanges data when microprocessor systems are connected. The data exchange can be effected bidirectionally. On transmission of data the circuit arrangement generates as bus master a bus clock speed and operates on receipt of data as a bus slave in accordance with the received clock signal. The circuit arrangement comprises at least one FIFO memory for receiving data.

### CROSS-REFERENCE TO RELATED APPLICATIONS

This application claims priority to German Patent Application Nos. 10 2010 043 929.0, filed Nov. 15, 2010; 10 2011 007 437.6, filed Apr. 14, 2011; and PCT/EP2011/063574, filed Aug. 5, 2011.

### FIELD OF THE INVENTION

The present invention relates to a method and a circuit arrangement for data transmission between processor chips.

### BACKGROUND OF THE INVENTION

Motor vehicles make widespread use of electronic control units (ECUs) for a wide variety of vehicle functions. In this context, there are control units (ECUs) for safety-critical applications, e.g. for the brakes, and for nonsafety critical applications, e.g. comfort functions such as air conditioning, seat heating, etc. For safety reasons, control units having differently classified safety requirements (ASIL levels) are usually implemented by separate, standalone electronic control units which are able to communicate with one another via digital vehicle data bus connections which are known per se. Examples of known vehicle data bus systems for ECU communication are CAN and FlexRay®.

The aim of the invention, inter alia, is to reduce the hardware involvement in motor vehicles by virtue of fewer control units needing to be installed in the vehicle.

The invention achieves this object by means of the control unit defined in the independent motor vehicle control unit claim.

The documents U.S. Pat. No. 5,251,304 and U.S. Pat. No. 5,812,881 disclose the practice of using a plurality of parallel complex bus interfaces which are known per se for the data transmission between integrated microelectronic chips (e.g. processor chips). These bus interfaces are typically provided for the transmission of addresses, control signals and data. This results in these inherently known complex bus systems (complete parallel bus interfaces) being a comparatively expensive solution for the data interchange between integrated electronic chips.

The present invention is concerned with the idea of providing an interface for electronic chips which is less expensive than interfaces in accordance with the prior art and can also be used more flexibly, and, in particular, is even extended and improved.

### INTRODUCTORY DESCRIPTION OF THE INVENTION

According to one embodiment, a circuit arrangement is provided which comprises a flexible, reconfigurable and comparatively simply designed and reliable parallel bidirectional digital interface. This interface allows communication between microcontrollers independently of bus systems for the connection to peripheral units.

According to one embodiment, the interface according to the invention extends the concept of an EDP interface as described in WO 2004/049159. A special feature of this interface is that the buffer used for holding data which are transmitted via the bus is an FIFO (First In-First Out) memory. The effect achieved by this, inter alia, is that communication is possible between dual-core, in particular multicore, microprocessor systems.

The advantage achieved by this, inter alia, is that it is possible to incorporate external controller functions into an electronic control unit more easily and less expensively. By way of example, two microcontrollers for control software having different safety levels can be incorporated into a control unit, the two microcontrollers each having a circuit arrangement for forming the digital parallel interface described here via which the two microcontrollers are directly connected to one another. This architecture allows the incorporation of applications having different safety levels without the application that has the low safety level influencing the application that has the high safety level, for example. In particular, the microcontroller having the lower safety level does not directly access the bus system of the microcontroller having the high safety level.

It is also now possible to use this to implement complex OEM software, which was not implementable in conventional multicore microprocessors for safety-critical applications on account of memory limitation (and other limitations), in a control unit together with the software functions for the safety-critical applications. There is still a separation for the software having a different safety level at microcontroller level in this case, however, so that the OEM software that is not checked with the high safety standard, such as a piece of software for brakes, does not disturb the software for the brakes in the case of error.

According to one embodiment, the present invention relates to a circuit arrangement for forming a digital interface. The interface according to the invention is subsequently also called an IPL (“Inter Processor Link”) interface. This comprises a digital data bus which interchanges data when microprocessor systems are connected, wherein this data interchange can take place bidirectionally (sending and receiving or reading and writing) and the circuit arrangement produces a bus clock when sending data as a bus master and operates on the basis of a received clock signal when receiving data as a bus slave, said circuit arrangement comprising at least one FIFO memory for sending data and/or at least one FIFO memory for receiving data.

According to one embodiment, the interface is reconfigurable between a sending mode and a receiving mode, wherein the reconfiguration takes place automatically on the basis of control signals which are interchanged between IPL interfaces that communicate with one another. Thus, each IPL interface may have at least one two-pole control signal port, with one pole serving as an input and the other pole serving as an output which are connected to the opposite interface in a crosswise manner.

The circuit arrangement preferably contains transmission parameters which are configurable for a parallel bus interface.

According to the invention, these parallel complete bus interfaces are also meant to be simplified such that a high data throughput and also more flexibility in the configuration are assured.

Depending on the availability of pins on the chips, the usable width of the bus can preferably be customized. Examples are a data length of 4, 8 or 16 bits.

The transmission speed can preferably be matched to the internal clock frequencies of the communicating chips.

The polarity of the clock signal for shift operations is preferably freely selectable.

In addition, this clock signal can preferably be masked out as required when the receiver is able to emulate the clocking, for example.

Configuration preferably allows the transmitted data to be protected using a CRC (Cyclic Redundancy Check) checksum.

A DMA module is understood to mean a controller for “Direct Memory Access”, that is to say a circuit module which allows direct memory access without the assistance of the microprocessor. In one prescribed configuration, a chip can preferably initiate a DMA request for a chip by means of a control signal so that the other chip provides data and allows data to be read from the first chip.

The microprocessor system(s) according to the invention is/are preferably (a) microcontroller(s).

According to one embodiment, a circuit arrangement for bidirectional data interchange between microprocessor systems or microcontrollers is provided. The circuit arrangement comprises a parallel bidirectional digital interface having a parallel bidirectional data port, an at least 2-pole control signal port for data flow control and at least one bidirectional clock signal port. The circuit arrangement is set up to take a signal applied to the control signal port as a basis for changing over between a sending mode and a receiving mode, wherein the circuit arrangement produces a bus clock and outputs it on the clock signal port in a sending mode as a bus master and operates on the basis of a clock signal received from a clock signal port when receiving data as a bus slave.

According to one embodiment, the parallel bidirectional digital interface has no address line ports.

According to one embodiment, the circuit arrangement also has a bus interface which may comprise data ports and address ports, for example. The bus interface can be used to connect the circuit arrangement to the microprocessor. The circuit arrangement therefore provides a connection to the bus system of the microprocessor.

According to one embodiment, the circuit arrangement comprises an FIFO memory for sending data and an FIFO memory for receiving data. The FIFO memories are used for buffer-storing the data.

According to one embodiment, the circuit arrangement comprises a conflict avoidance mechanism which is set up to enable data transmission only after a check on the control signal port for a control signal from the opposite side. The conflict avoidance mechanism is used for avoiding conflicts which can arise when the two interfaces communicating with one another are simultaneously ready to send. In particular, according to one embodiment, this can be accomplished by providing for each interface, upon identification of a conflict, to wait for a waiting time stipulated for this interface beforehand before a fresh sending attempt is made. This makes it possible to ensure that the fresh sending attempts are repeated at different times and therefore only one of the two interfaces is active as a bus master.

According to one embodiment, the circuit arrangement can be changed over to at least one slave sending mode in which the circuit arrangement operates as a bus slave on the basis of a clock signal received from the clock signal port and sends data upon a request from the opposite interface. The slave sending mode is a compatibility mode for interfaces which have no dedicated slave mode.

According to one embodiment, a microprocessor system (microcontroller) is provided. The microprocessor system comprises at least one microprocessor having a bus system, a circuit arrangement having an IPL interface and a bus interface which is connected to the bus system of the microprocessor, a memory and a DMA module for accessing the memory, wherein the DMA module can be actuated by the circuit arrangement independently of the microprocessor. The memory and also the DMA module may be connected to the bus system of the microprocessor.

The circuit arrangement therefore provides a parallel bidirectional interface for the connection of a further microprocessor independently of the bus system of the microprocessor. The microprocessors can be connected to one another via the parallel bidirectional interface without directly accessing the respective bus system of the other processor in each case. This is particularly favorable when coupling microprocessors having different safety levels.

### BRIEF DESCRIPTION OF THE DRAWING FIGURES

Further preferred embodiments emerge from the subclaims and the description below of an exemplary embodiment with reference to figures, in which:

FIG. 1A shows a schematic depiction of a parallel bus interface based on the prior art,

FIG. 1B shows a schematic depiction of an example of a bus interface that has been simplified according to the invention,

FIG. 2 shows a highly schematic depiction of the functions of a microcontroller having an IPL interface according to the invention,

FIG. 3 shows the exemplary design of an IPL circuit arrangement for handling the data transfer,

FIG. 4 shows a depiction of timing diagrams for the data transmission between two IPL data transmission chips according to the invention,

FIG. 5 shows a further depiction of timing diagrams for the data transmission between two data transmission chips according to the invention in order to illustrate a bus conflict during sending,

FIG. 6 shows a further depiction of timing diagrams for the data transmission between two data transmission chips according to the invention in order to illustrate the handling of a bus conflict during sending, and

FIG. 7 shows a further depiction of timing diagrams for the data transmission between two data transmission chips according to the invention in order to illustrate the initiation of a DMA (Direct Memory Access).

### DETAILED DESCRIPTION OF THE INVENTION

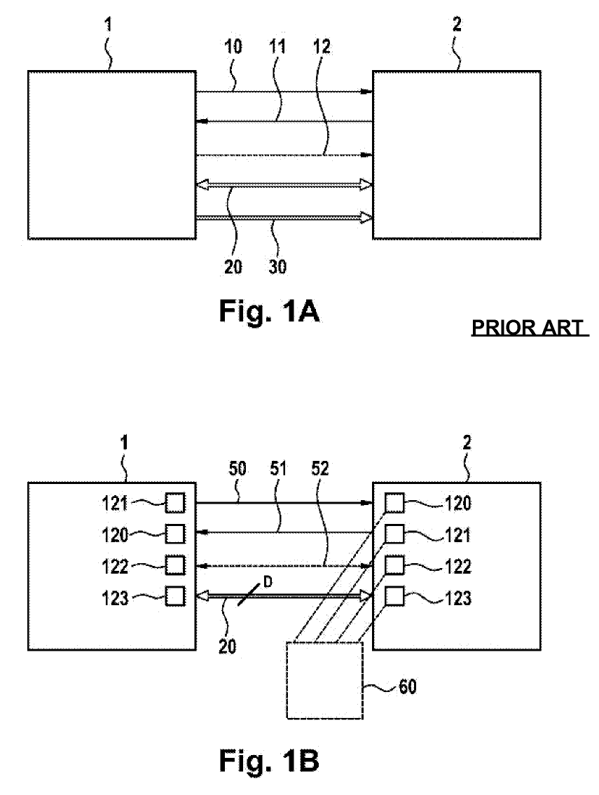

In FIG. 1A (prior art), microcontroller (μC) 1 is always operated in master mode and therefore determines the addresses for read and write access operations in the microcontroller 2. The microcontroller 2 is always operated in slave mode. Address lines 30 are laid unidirectionally from the master to the slave. Data lines 20 are bidirectional. The master microcontroller 1 sends control signals 10 to the slave microcontroller 2 in order to stipulate the meaning of the data signals. The slave microcontroller 2 sends response signals 11 to the microcontroller 1. For synchronized data transmission, synchronization signals 12 are also required.

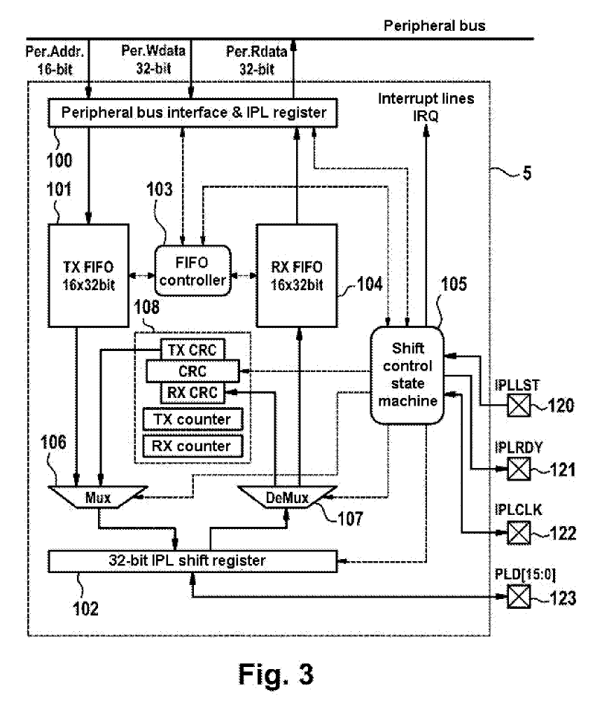

FIG. 1B shows an example of a design—simplified according to the invention—for a parallel bus interface, which is also called a digital bidirectional parallel interface or an IPL interface. Address lines 30 (FIG. 1A) are not present. Each microcontroller (μC) 1 or 2 has the four pins 120 to 123, which are also shown in FIG. 3. Pin 121 of μC 1 is connected to pin 120 of the μC 2 by means of output line 50. Pin 120 of μC 1 is connected to pin 121 of the μC 2 by means of input line 51. The control lines are therefore connected to the other μC in each case crosswise. Just three control signals are required: a control signal 50, 51, one for each direction, and a synchronization signal 52 which transmits the bus clock.

The transfer between the microcontrollers via the respective IPL interface is limited to the data transmitted via data lines 20, in addition to the signals on the control lines described above and the bus clock. There are thus no address lines present. The data lines 20 are parallel data lines, for example 4, 8 or 16 data lines. A corresponding number of pins 123 are present in each case.

Each microcontroller 1 or 2 can be configured as a master or a slave for a data transmission (bidirectional data interchange). A microcontroller is changed over to master or slave mode for the most part automatically. When microcontroller 1 starts sending data, this forces the other microcontroller 2 to be automatically transferred to the slave mode, and vice versa.

The changeover can take place as follows, for example: initially, both interfaces are in a quiescent state (idle), since no data need to be transmitted. If the microcontroller 1 now provides data for transmission, the IPL interface associated with said microcontroller signals that it is ready to send by outputting a control signal 50 on pin (port) 121, which is connected to pin (port) 120 of the IPL interface of microcontroller 2. The IPL interface of microcontroller 2 accordingly changes to a slave mode and awaits the bus clock (synchronization signal 52) which is output by the sending interface on pin 122. The IPL interface of the microcontroller 2 thus changes to the slave receiving mode and operates on the basis of the received bus clock. Following transmission of the data, both IPL interfaces change to a quiescent state again.

Furthermore, FIG. 1B shows a diagnosis module 60 which can be connected to microprocessor module 1 or 2 via the lines described above for debugging operations (FIG. 1B indicates only the connection to the IPL interface of microprocessor system 2 by dashed lines).

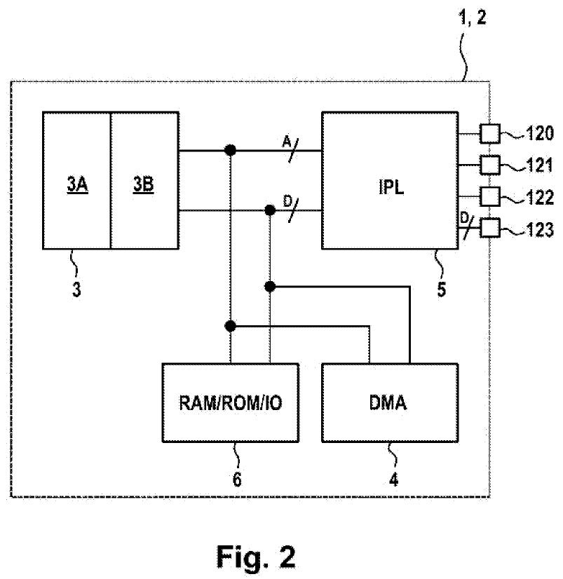

FIG. 2 schematically shows the design of a microcontroller 1 according to the invention with an IPL interface 5. The IPL interface is connected by means of the usual bus systems to the microprocessor unit 3, which, in the example shown, contains two processor cores 3A, 3B protected on the basis of the principle of core redundancy. In particular, the bus system has data lines D and address lines A. In addition to a memory area 6, for example a ROM or RAM, the microcontroller furthermore comprises a DMA module 4 which can independently perform data interchange operations between the memories of the memory area 6 and the memories of the IPL module 5, for example.

The circuit arrangement shown in FIG. 3 is the actual IPL interface 5 and handles the data transfer. The IPL interface 5 is arranged in a microcontroller 1 or 2. For the sending path and for the receiving path, FIFO memories (one register set in each case) 101 and 104 are used in order to allow continuous datastreams.

The IPL interface has the four electrical ports 120 to 123 for connection to another μC or to a diagnosis device for debugging, the electrical port 123 being a parallel data port having 4, 8, 16 or 32 lines, for example.

The ports are assigned as follows:
120: “Lists”—control input (control signal input)
121: “Ready”—control output (control signal output)
122: “Clock”—output for bus clock in both directions
123: “Data”—parallel data bus

The ports described above, particularly port 123, may comprise a plurality of pins which are routed to the outside on the chip.

The FIFO controller 103 arranged between the FIFO memories 101 and 104 is used for ascertaining and checking the status of the two FIFO memories. It is thus possible to establish whether the FIFO memories are full or empty and whether they are above or below specific fill thresholds (“watermarks”, “overrun states”). The FIFO controller 103 retrieves suitable actions according to the state of the memories, such as “transmit data” or “abort”. If the send FIFO 101 (TX FIFO) is being filled with data, for example, the master sending mode is initiated provided that the IPL interface is in the quiescent state, i.e. no data are being sent or received.

FSMs shift controller 105 is a state machine which takes the state lines shown by means of the dashed lines as a basis for bringing about actions such as interrupts via the IRQ lines.

100 denotes a peripheral bus interface having IPL registers which is connected to the peripheral bus (address bus and data bus in FIG. 2) of the microcontroller 1.

102 denotes a 32-bit IPL shift register for outputting the data on the parallel data port 123.

Multiplexer 106 mixes the data that are to be output with the checksum information (CRC check bits). Demultiplexer 107 removes the useful data from the check data upon reception. The check data are processed in CRC logic 108, where an error check is also performed.

Furthermore, the interface comprises a configuration register which can be used to configure properties of the interface in a suitable manner (e.g. the width of the data port 123).

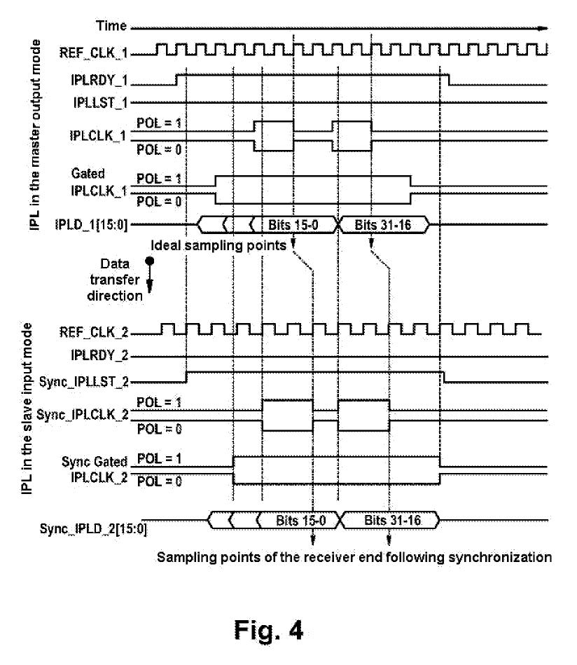

The timing diagrams in FIG. 4 show the data transmission between the IPL (inter processor link) circuit arrangement in master output mode and a further IPL circuit arrangement in slave mode (reception of data). The master output mode is initiated when the send FIFO 101 is filled with new data. In FIG. 4, it is also assumed that both IPL interfaces are in a quiescent state, i.e. neither of the two interfaces is outputting a signal (High) on its control output IPLRDY_1, IPLRDY_2. Correspondingly, the control inputs IPLLST_1 and IPLLST_2 are at Low. It should be noted that IPLRDY_1 is connected to IPLLST_2 and that IPLRDY_2 is connected to IPLLST_1.

If the send FIFO 101 of one IPL interface is now filled with data, said IPL interface uses IPLRDY_1 to output a signal (High) which is received by IPLLST_2. As a result, the second IPL interface (IPL in that slave input mode) changes to slave receiving mode and synchronizes itself to the synchronization signal that is output by the first IPL interface (IPL in the master output mode). When data transmission has taken place, both IPL interfaces change to the quiescent state again, i.e. both control outputs IPLRDY_1, IPLRDY_2 have Low applied to them.

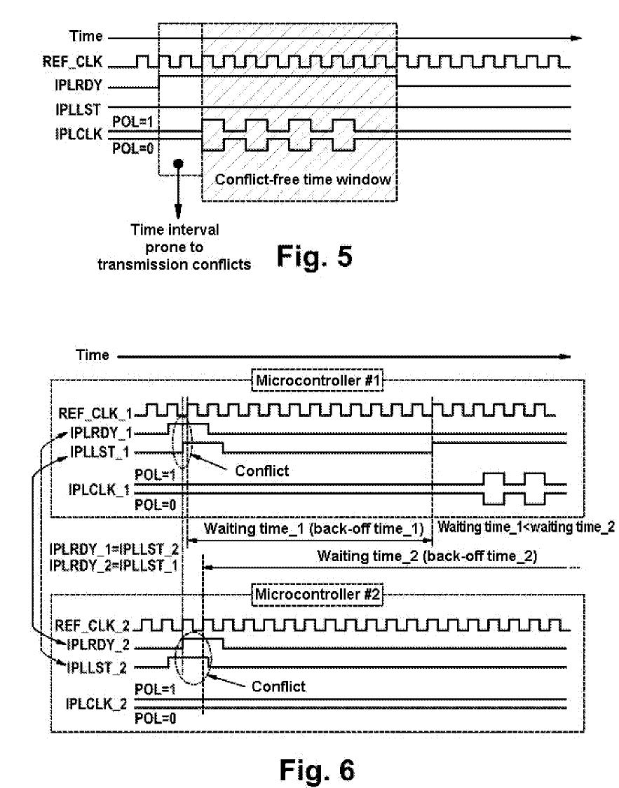

FIGS. 5 and 6 show the conflict avoidance mechanism based on one embodiment. A conflict can occur when both IPL interfaces indicate that they are ready to send by outputting a control signal (High) on their control outputs IPLRDY_1 and IPLRDY_2 at the same time or in brief succession. The critical time window for this is indicated in FIG. 5. When this time window has elapsed, the other IPL interface in each case has safely changed to slave mode. There is thus a conflict-free time window available so long as one IPL interface remains in master mode. Conflicts which arise in this “conflict-free” time window can only stem from hardware errors.

FIG. 6 shows that the IPL interface of microcontroller 2 has indicated that it is ready to send shortly after the IPL interface of microcontroller 1 without the IPL interface of microcontroller 2 having already reacted to the ready-to-send state of the IPL interface of microcontroller 1. Since both control inputs IPLLST_1 and IPLLST_2 now each have a control signal, both IPL interfaces identify the conflict and stop further initiation of the data sending. Both IPL interfaces change to the quiescent state for a given time (waiting time_1, waiting time_2). The respective waiting times are different for each IPL interface and can be stipulated in a suitable manner beforehand, for example. In the present example, it is assumed that waiting time_1 is shorter than waiting time_2, which means that the IPL interface of microcontroller 1 leaves the quiescent state and indicates that it is ready to send again by outputting a control signal on control output IPLRDY_1 earlier than the IPL interface of microcontroller 2. Since the IPL interface of microcontroller 2 is still in quiescent state, no control signal is output on IPLRDY_2. A fresh conflict is avoided as a result.

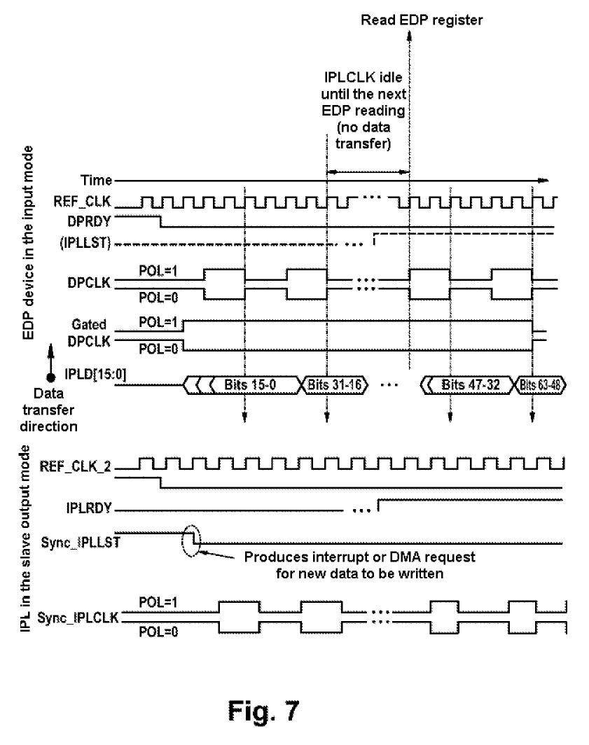

The timing diagram in FIG. 7 shows the signal profile for an arrangement in which an EDP diagnosis module 60 (debugging by means of an enhanced data port), shown in FIG. 1, is connected to a microprocessor system 2 which has an IPL interface. The IPL interface is used for connection to the EDP diagnosis module 60.

In this case, the EDP diagnosis module 60 is in a master input mode. The microprocessor system 2 according to the invention which is connected thereto and has an IPL interface is in a slave output mode (slave sending mode). The slave sending mode is a compatibility mode for interfaces which can be operated only in master mode. Such interfaces always prescribe the bus clock irrespective of whether they are sending or receiving. To this end, the IPL interface is put into slave sending mode by means of software.

The timing diagram shows how the EDP diagnosis module 60 produces a request which initiates a DMA. Following this request, a DMA transfer is started in the microcontroller 2 according to the invention in order to supply the EDP diagnosis module 60 with the requested data.

It should be noted that the EDP interface sets EDPRDY (control output) to Low in order to indicate that it is requesting new data. Accordingly, IPLLST of the IPL interface likewise changes from High to Low, which results in the DMA transfer or interrupt being initiated as described above. The send FIFO 101 of the IPL interface is accordingly filled with data. Which data are loaded into the send FIFO 101 is prescribed by the software. When all the data has been loaded, the IPL interface indicates that it is ready to send by setting IPLRDY to High.

Accordingly, the IPL interface can also be changed over to a slave receiving mode in order to receive data from an EDP interface.

Furthermore, a μC which has the IPL interface described above may naturally also have one or more further interfaces, such as CAN.

While the above description constitutes the preferred embodiment of the present invention, it will be appreciated that the invention is susceptible to modification, variation and change without departing from the proper scope and fair meaning of the accompanying claims.

1. A circuit arrangement (IPL) for forming a digital interface (102, 121, 122, 123) comprising a digital data bus (123) which interchanges data when at least two microprocessor systems are connected to provide data interchange, wherein the data interchange can take place bidirectionally between the microprocessor systems and the circuit arrangement produces a bus clock when sending data as a bus master and operates on the basis of a received clock signal when receiving data as a bus slave, and at least one of a FIFO memory (101) for sending data and a FIFO memory (104) for receiving data.

2. The circuit arrangement as claimed in claim 1, further comprising in that it the circuit arrangement is integrated in a microprocessor module (1, 2) having a microprocessor (3) which integrates the microprocessor systems and at least one DMA module (4), wherein the DMA module can read and write to the FIFO memory (101, 104) independently of read or write operations of one of the microprocessor systems.

3. The circuit arrangement as claimed in claim 2, further comprising in that the microprocessor is a multicore processor (3) which is designed to have a plurality of cores which operate in clock sync.

4. The circuit arrangement as claimed in claim 2, further comprising a read only memory of semiredundant design and the FIFO memory is of essentially fully redundant design.

5. The circuit arrangement as claimed in claim 1 in that the interface further comprises a shift control state machine (105) which controls the interchange of the data between the FIFO memory (101, 104) and the data bus.

6. The circuit arrangement as claimed in claim 1 in that the interface further comprises a data protection module (108) which, when sending data, appends a piece of check information to the data and, when receiving, checks the received data for correctness using the received check information linked to the data and removes the check information from the data in the process.

7. The circuit arrangement as claimed in claim 1, wherein in that the interface comprises no address lines.

8. The circuit arrangement as claimed in claim 1 further comprising in that for the data transmission the interface transmits the data via a plurality of parallel data lines, wherein the number of data lines used is configurable.

9. The circuit arrangement as claimed in claim 1 further comprising in that the interface is set up such that the microprocessor systems can be connected to a diagnosis module (60) via the interface for debugging operations.

10. A motor vehicle control unit comprising a first microprocessor system for safety-critical applications, a second microprocessor system which communicates with the first microprocessor system and which complies with a lower safety level than the first microprocessor system.

11. A motor vehicle control unit comprising a first microprocessor system for safety-critical applications, a second microprocessor system which communicates with the first microprocessor system and which complies with a lower safety level than the first microprocessor system, the first microprocessor system is connected to the second microprocessor system via a circuit arrangements having a digital interface (102, 121, 122, 123) having a digital data bus (123) which interchanges data when the first and second microprocessor systems are connected to provide data interchange, wherein the data interchange can take place bidirectionally between the microprocessor systems and the circuit arrangement produces a bus clock when sending data as a bus master and operates on the basis of a received clock signal when receiving data as a bus slave, and at least one of a FIFO memory (101) for sending data and a FIFO memory (104) for receiving data.

12. A method for transmitting data into and out of a microprocessor system (1), comprising providing a circuit arrangement having IPL a digital interface having a digital data bus (123) which interchanges data when at least two microprocessor systems are connected to provide data interchange, wherein the data interchange can take place bidirectionally between the microprocessor systems and the circuit arrangement produces a bus clock when sending data as a bus master and operates on the basis of a received clock signal when receiving data as a bus slave, and at least one of a FIFO memory (101) for sending data and a FIFO memory (104) for receiving data and the IPL interface is used to perform debugging operations.

13. The method as claimed in claim 12, further comprising the IPL interface changes over to a reception mode when it receives a control signal on a control signal input, wherein it receives a bus clock on a clock signal port and operates on the basis of this bus clock.

14. The method as claimed in claim 12 further comprising the IPL interface outputs data in a sending mode by outputting a control signal and producing a bus clock which is output on the clock signal port.
